(19) United States
(12) Patent Application Publication
(10) Pub. No.: US 2025/0383837 A1
(43) Pub. Date: Dec. 18, 2025

(54) USER INTERFACES FOR AUDIO ROUTING

(71) Applicant: Apple Inc., Cupertino, CA (US)

(72) Inventor: Christopher J. SANDERS, San Jose, CA (US)

(21) Appl. No.: 19/314,866

(22) Filed: Aug. 29, 2025

Related U.S. Application Data
(63) Continuation of application No. 18/383,371, filed on Oct. 24, 2023, now Pat. No. 12,423,052.
Application No. 18/383,371 is a continuation of application No. 17/824,510, filed on May 25, 2022, now Pat. No. 11,847,378.
(60) Provisional application No. 63/197,425, filed on Jun. 6, 2021.

(51) Int. Cl. G06F 3/16; G06F 3/04842; H04R 3/00

(52) U.S. Cl. CPC G06F 3/165; G06F 3/04842; H04R 3/00

(57) ABSTRACT

The present disclosure generally relates to user interface for audio routing. In some examples, a computer system detects an audio device and displays a selectable option in accordance with a determination that a set of criteria is met. The selectable option, when selected, enables the computer system to connect to the audio device and transmit audio data to the audio device.

### CROSS-REFERENCE TO RELATED APPLICATIONS

This application is a continuation of U.S. patent application Ser. No. 18/383,371, entitled “USER INTERFACES FOR AUDIO ROUTING,” filed Oct. 24, 2023, which is a continuation of U.S. patent application Ser. No. 17/824,510 (now U.S. Pat. No. 11,847,378), entitled “USER INTERFACES FOR AUDIO ROUTING,” filed May 25, 2022, which claims priority to U.S. Provisional Patent Application Ser. No. 63/197,425, entitled “USER INTERFACES FOR AUDIO ROUTING,” filed on Jun. 6, 2021, the contents of each of which are hereby incorporated by reference in their entirety.

### FIELD

The present disclosure relates generally to computer user interfaces, and more specifically to techniques for managing audio output.

### BACKGROUND

Electronic devices can play various types of media that include audio, such as music tracks, podcasts, audio books, and videos. Electronic devices can also provide audio data via wireless connections to audio output devices such as wireless speakers and wireless headphones.

### BRIEF SUMMARY

Some techniques for managing audio output using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for managing audio output. Such methods and interfaces optionally complement or replace other methods for managing audio output. Such methods and interfaces reduce the cognitive burden on a user and produce a more efficient human-machine interface. Such methods and interfaces also reduce the number of inputs that are necessary for connecting an audio device to an electronic device. For battery-operated computing devices, such methods and interfaces conserve power and increase the time between battery charges.

In accordance with some embodiments, a method is described. The method is performed at a computer system that is in communication with a display generation component. The method comprises: while displaying, via the display generation component, content of a first type, detecting an audio device; and in response to detecting the audio device: in accordance with a determination that a set of criteria is met, displaying a selectable option that, when selected via user input, causes the computer system to provide output content audio to the audio device; and in accordance with a determination that the set of criteria is not met, forgoing displaying the selectable option.

In accordance with some embodiments, a non-transitory computer-readable storage medium is described. The non-transitory computer-readable storage medium stores one or more programs configured to be executed by one or more processors of a computer system that is in communication with a display generation component, the one or more programs including instructions for: while displaying, via the display generation component, content of a first type, detecting an audio device; and in response to detecting the audio device: in accordance with a determination that a set of criteria is met, displaying a selectable option that, when selected via user input, causes the computer system to provide output content audio to the audio device; and in accordance with a determination that the set of criteria is not met, forgoing displaying the selectable option.

In accordance with some embodiments, a transitory computer-readable storage medium is described. The transitory computer-readable storage medium stores one or more programs configured to be executed by one or more processors of a computer system that is in communication with a display generation component, the one or more programs including instructions for: while displaying, via the display generation component, content of a first type, detecting an audio device; and in response to detecting the audio device: in accordance with a determination that a set of criteria is met, displaying a selectable option that, when selected via user input, causes the computer system to provide output content audio to the audio device; and in accordance with a determination that the set of criteria is not met, forgoing displaying the selectable option.

In accordance with some embodiments, a computer system is described. The computer system is configured to communicate with a display generation component. The computer system comprises: one or more processors; and memory storing one or more programs configured to be executed by the one or more processors, the one or more programs including instructions for: while displaying, via the display generation component, content of a first type, detecting an audio device; and in response to detecting the audio device: in accordance with a determination that a set of criteria is met, displaying a selectable option that, when selected via user input, causes the computer system to provide output content audio to the audio device; and in accordance with a determination that the set of criteria is not met, forgoing displaying the selectable option.

In accordance with some embodiments, a computer system is described. The computer system is configured to communicate with a display generation component. The computer system comprises: means for, while displaying, via the display generation component, content of a first type, detecting an audio device; and means for, in response to detecting the audio device: in accordance with a determination that a set of criteria is met, displaying a selectable option that, when selected via user input, causes the computer system to provide output content audio to the audio device; and in accordance with a determination that the set of criteria is not met, forgoing displaying the selectable option.

In accordance with some embodiments, a computer program product is described. The computer program product comprises one or more programs configured to be executed by one or more processors of a computer system that is in communication with a display generation component, the one or more programs including instructions for: while displaying, via the display generation component, content of a first type, detecting an audio device; and in response to detecting the audio device: in accordance with a determination that a set of criteria is met, displaying a selectable option that, when selected via user input, causes the computer system to provide output content audio to the audio device; and in accordance with a determination that the set of criteria is not met, forgoing displaying the selectable option.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for managing audio output, thereby increasing the effectiveness, efficiency, and user satisfaction with such devices. Such methods and interfaces may complement or replace other methods for managing audio output.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6I illustrate exemplary user interfaces for managing audio output, in accordance with some embodiments.

FIGS. 7A-7C are a flow diagram illustrating a method for managing audio output, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for managing audio output. For example, when viewing content on an electronic device, users must typically provide a set of user inputs to cause the electronic device to switch audio output between a first audio device and a second audio device. The disclosed techniques reduce a number of user inputs needed by the user to switch audio output between audio devices. Such techniques can reduce the cognitive burden on a user who manages audio output, thereby enhancing productivity. Further, such techniques can reduce processor and battery power otherwise wasted on redundant user inputs.

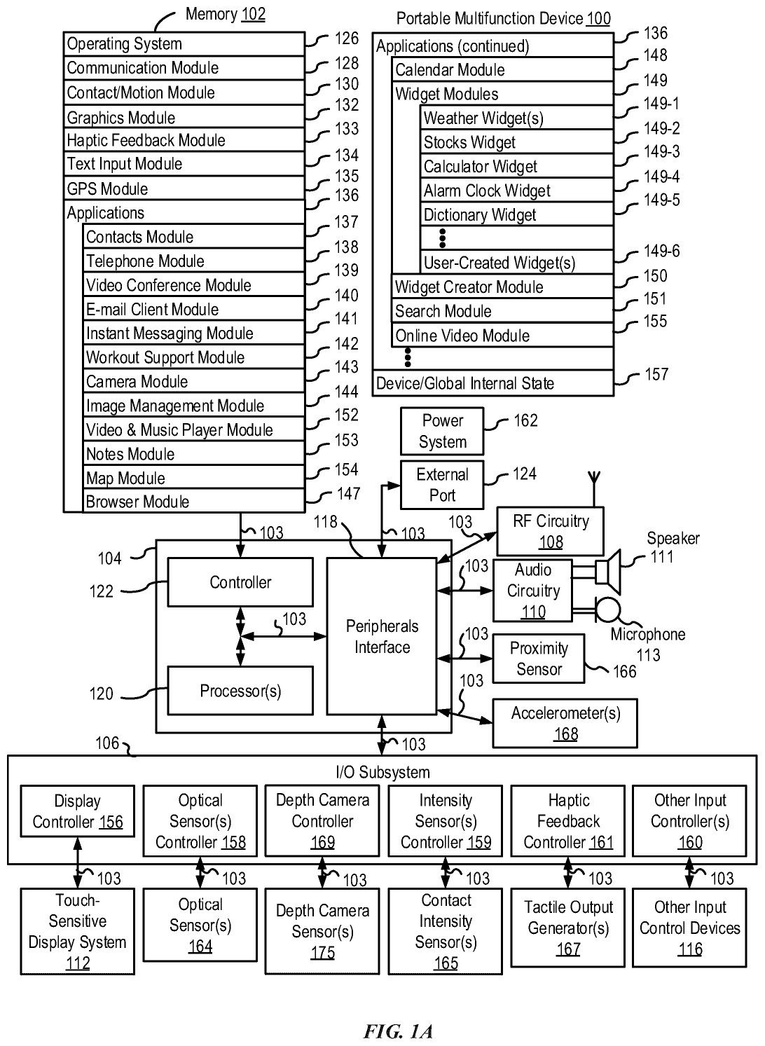

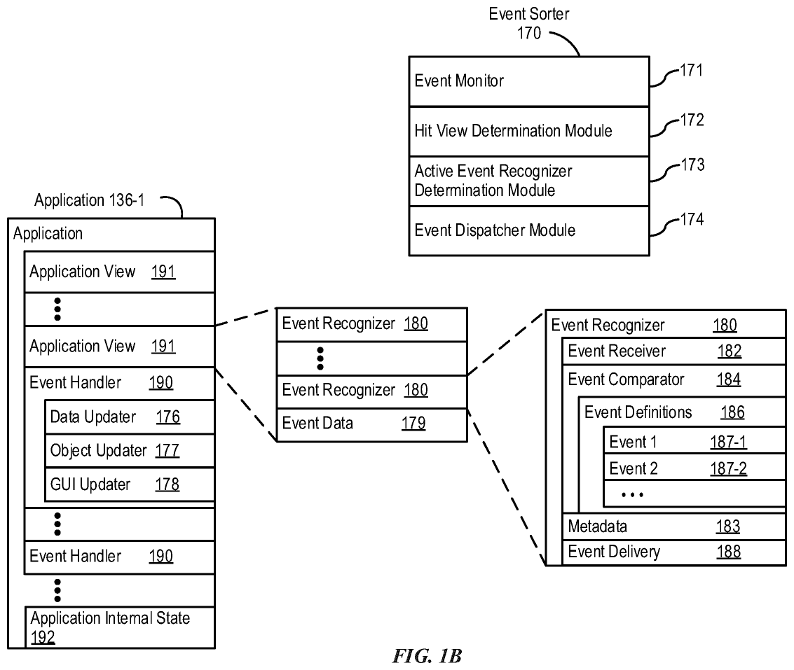

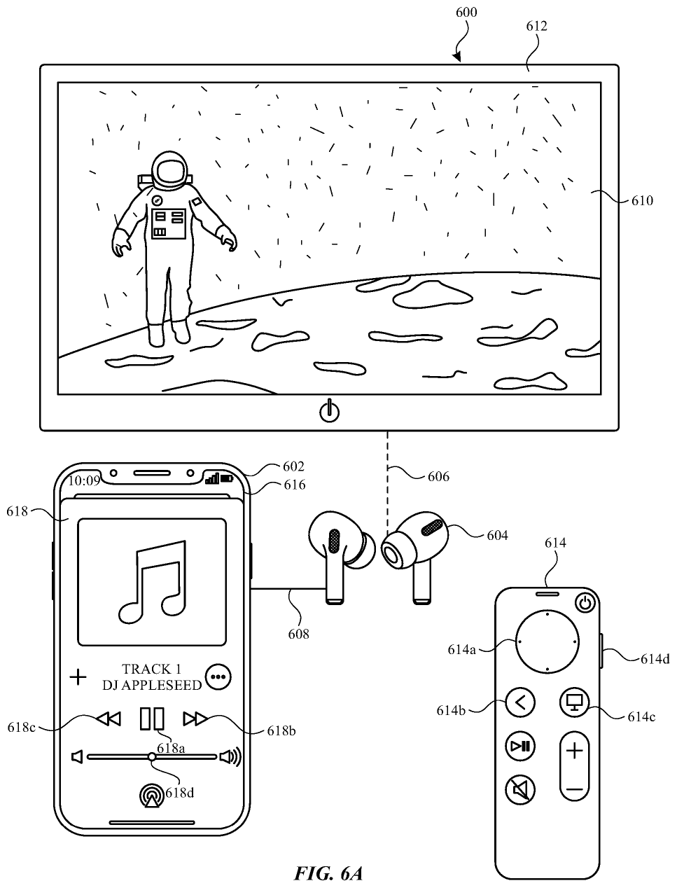

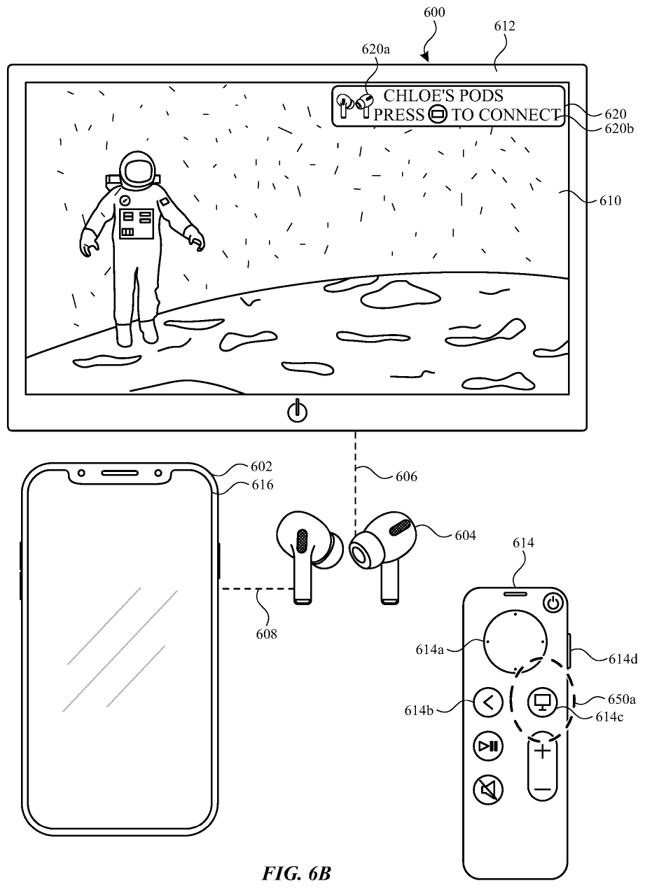

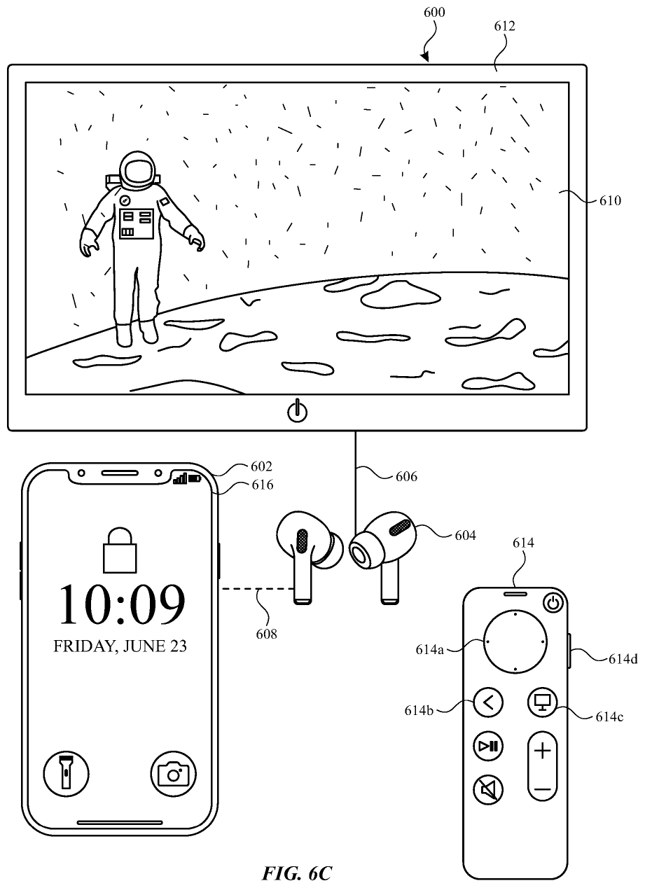

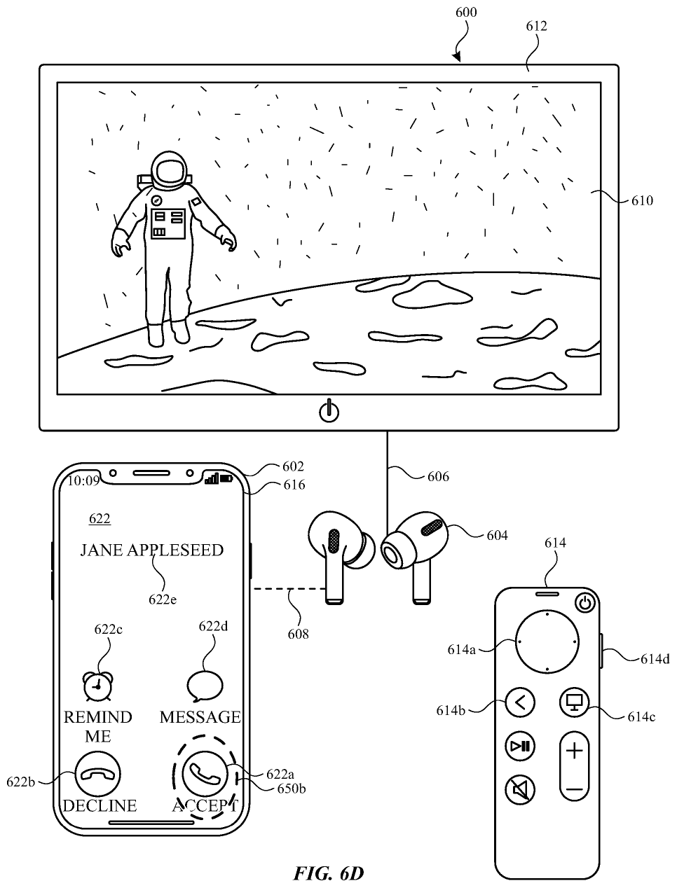

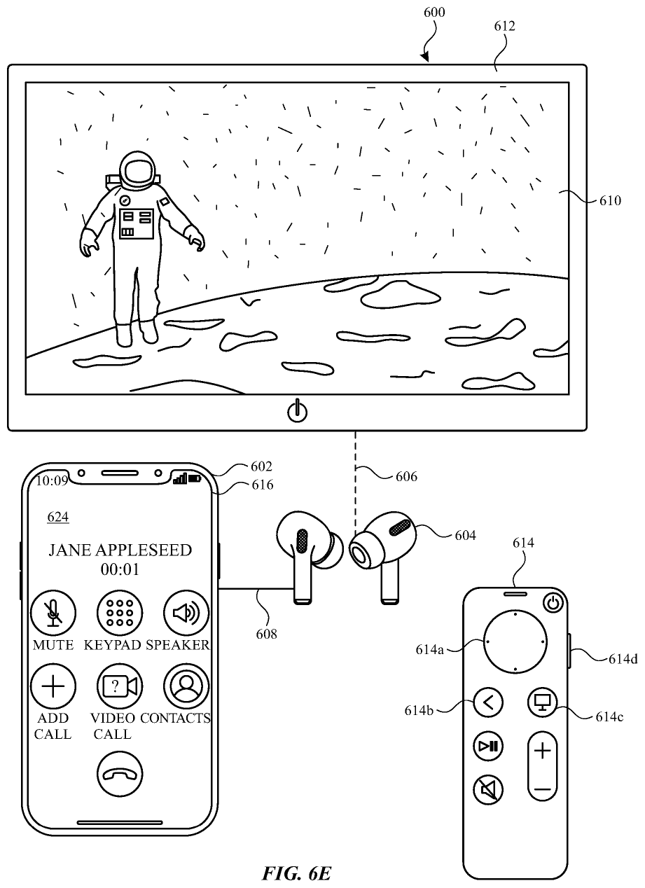

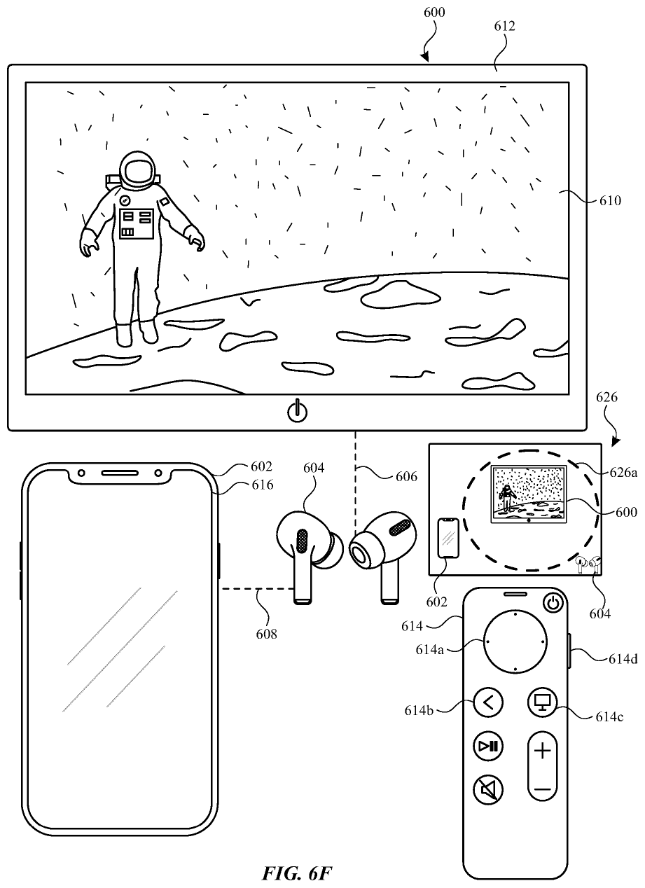

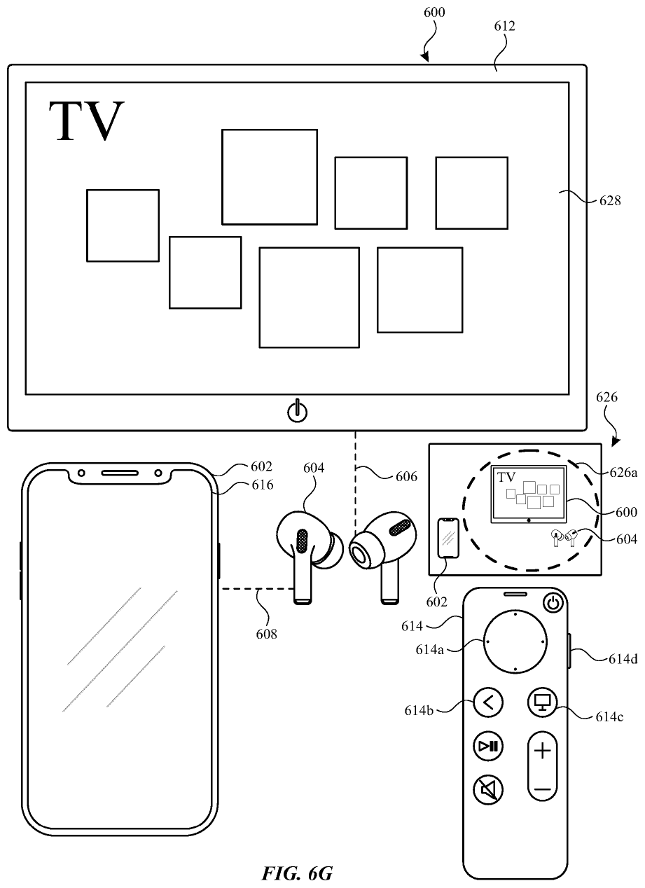

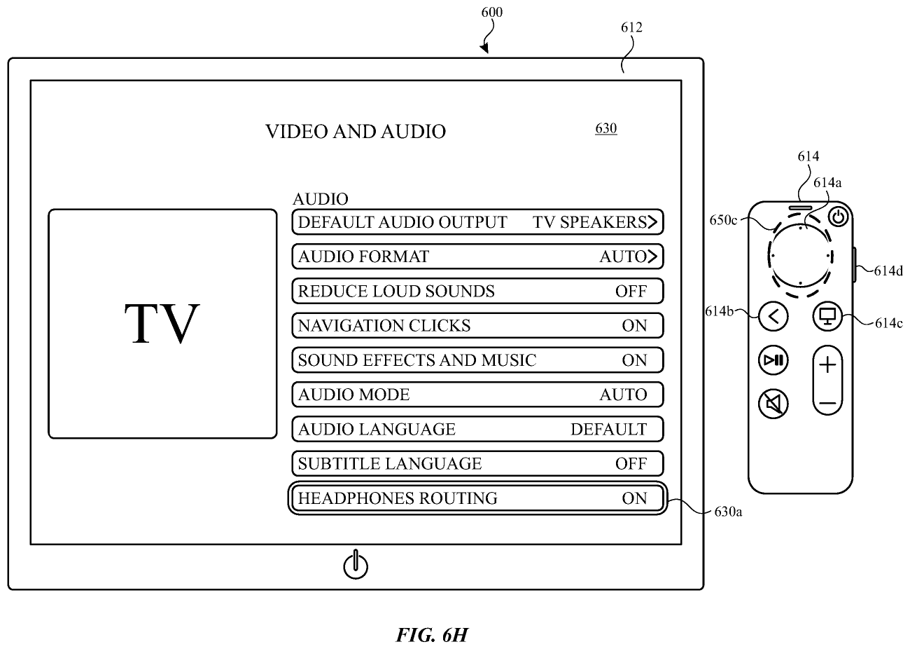

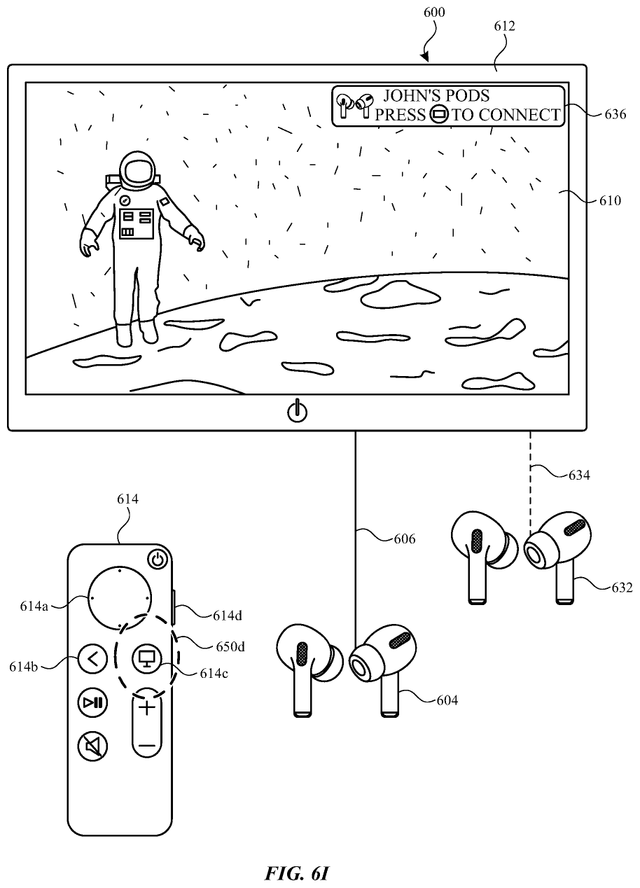

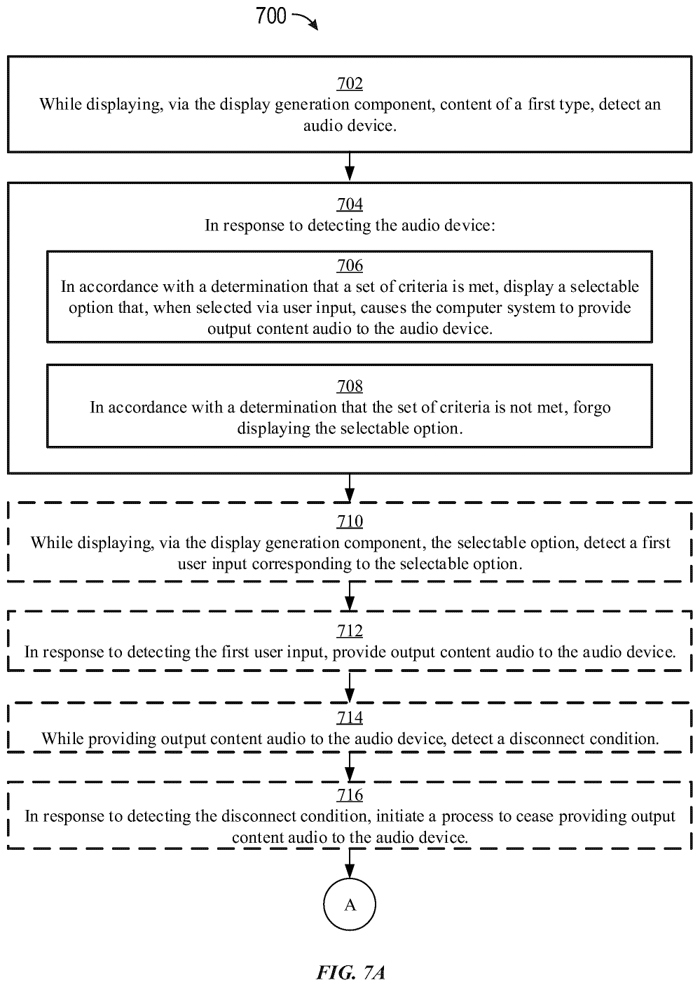

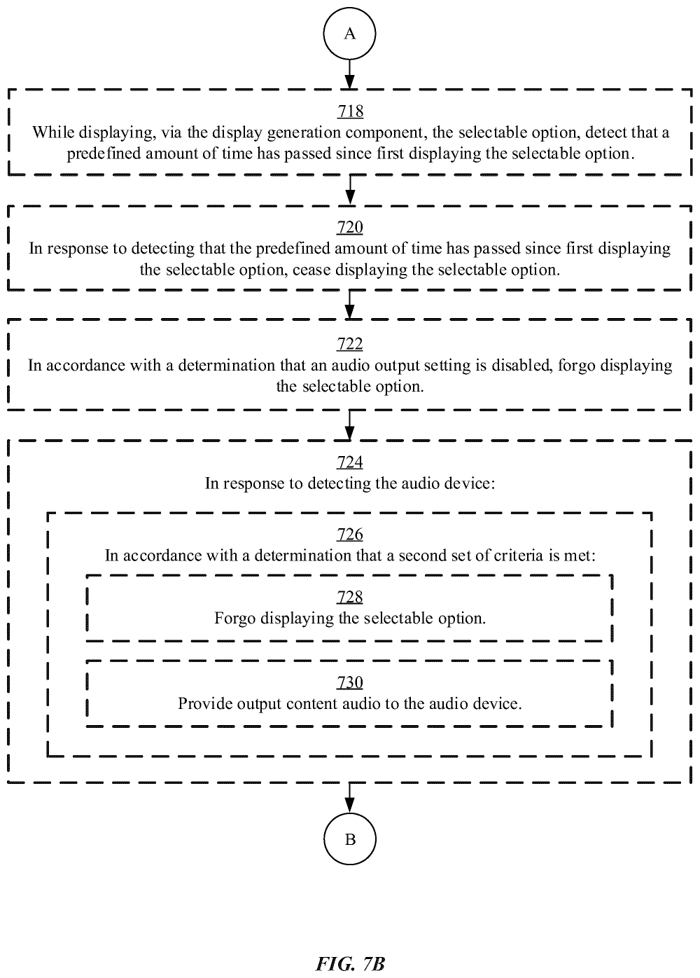

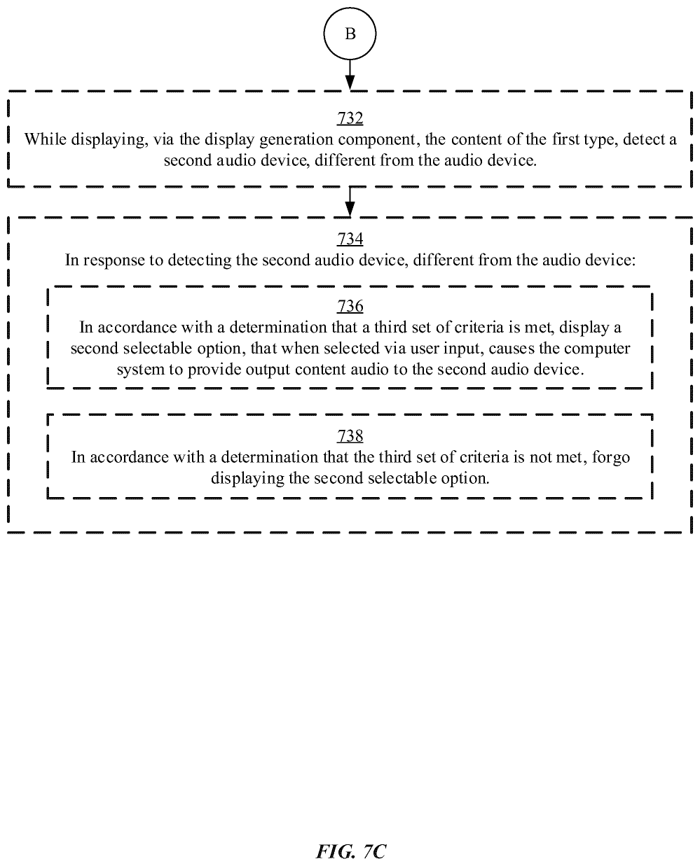

Below, FIGS. 1A-1B, 2, 3, 4A-4B, and 5A-5B provide a description of exemplary devices for performing the techniques for managing audio output. FIGS. 6A-6I illustrate exemplary user interfaces for managing audio output. FIGS. 7A-7C are a flow diagram illustrating methods of managing audio output in accordance with some embodiments. The user interfaces in FIGS. 6A-6I are used to illustrate the processes described below, including the processes in FIGS. 7A-7C.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

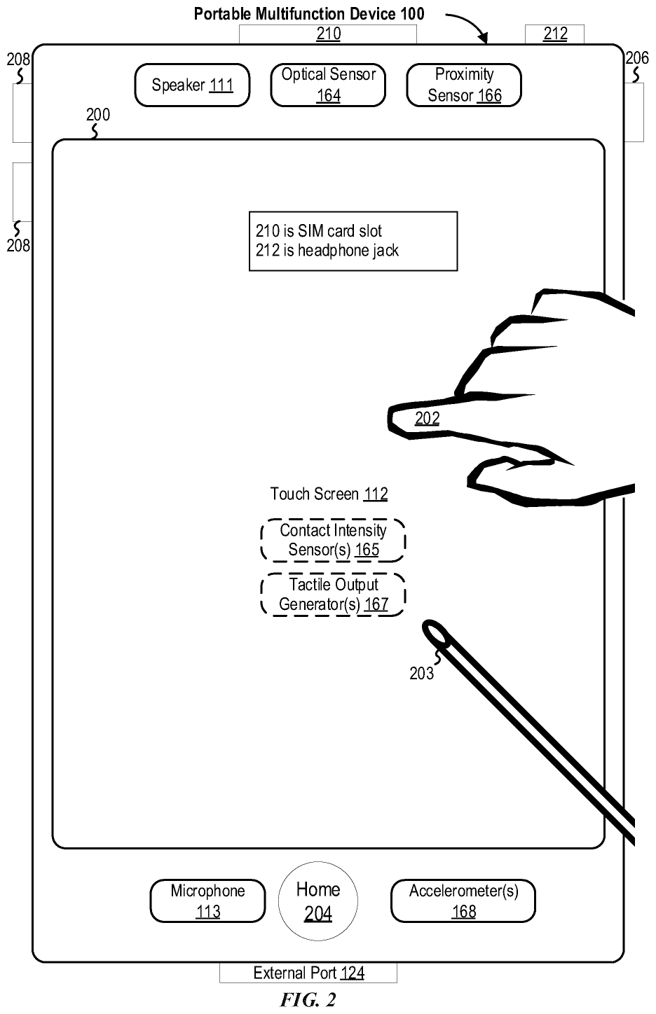

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

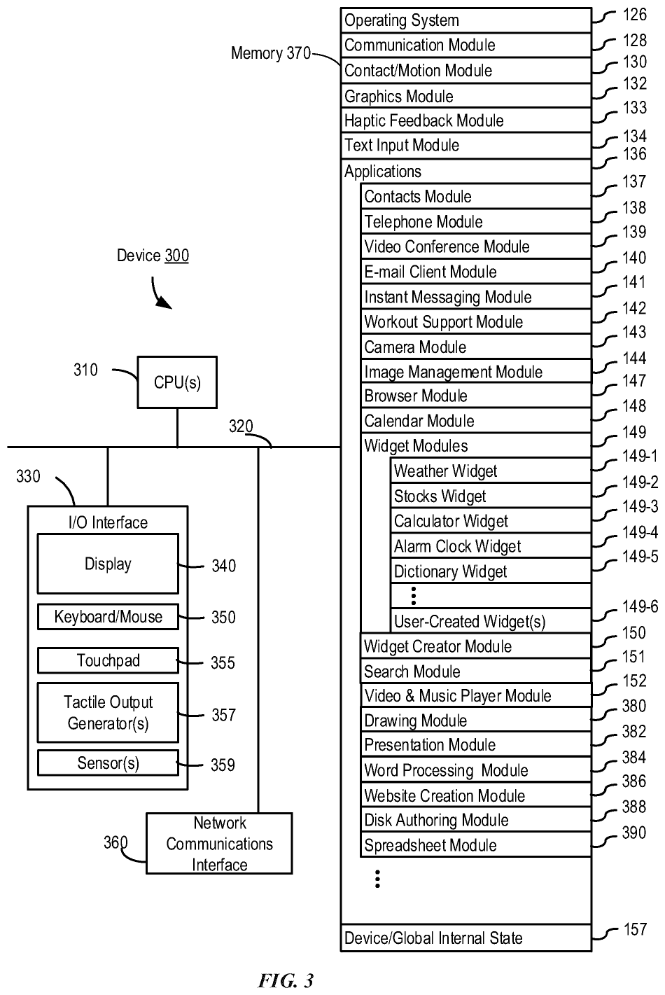

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

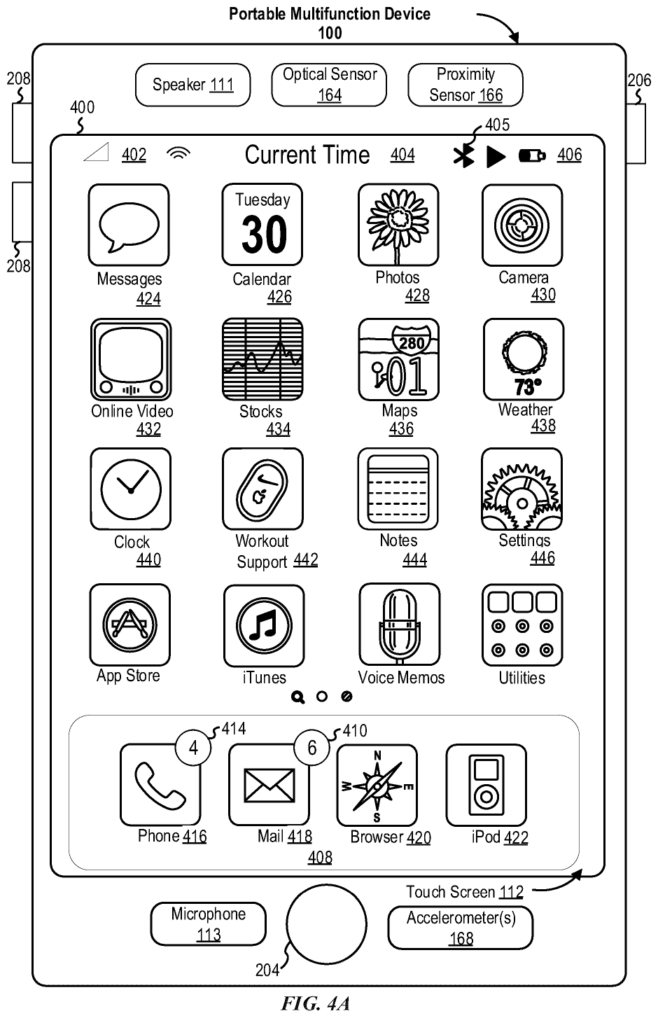

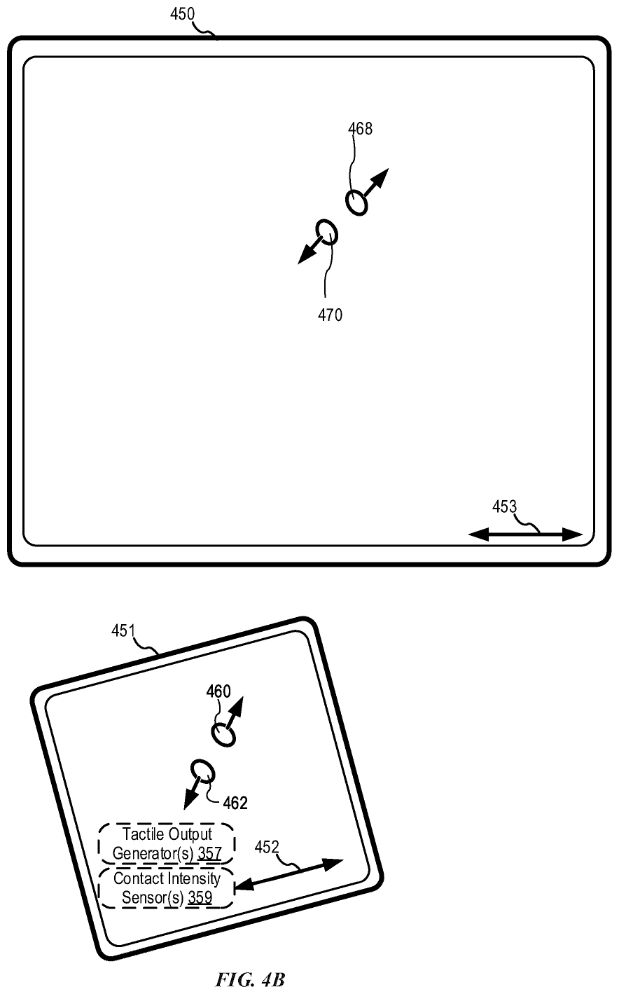

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

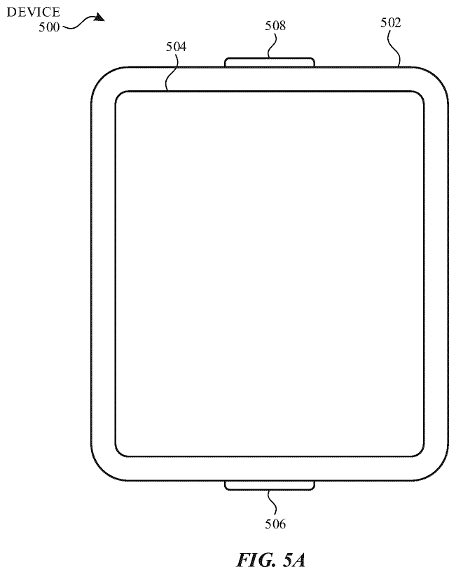

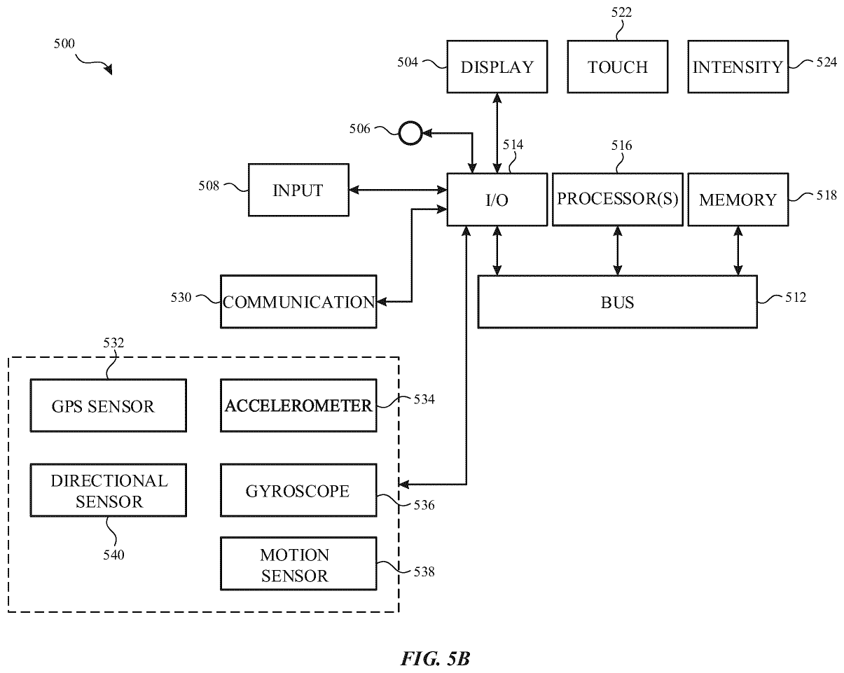

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 700 (FIGS. 7A-7C). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

Attention is now directed towards embodiments of user interfaces (“UI”) and associated processes that are implemented on an electronic device, such as portable multifunction device 100, device 300, or device 500.

FIGS. 6A-6I illustrate exemplary user interfaces for managing audio output, in accordance with some embodiments. The user interfaces in these figures are used to illustrate the processes described below, including the processes in FIGS. 7A-7C.

FIG. 6A illustrates first electronic device 600 (e.g., device 100, 300, and/or 500), second electronic device 602 (e.g., device 100, 300, and/or 500), and audio device 604 (e.g., wireless headphones), where audio device 604 is in communication with first electronic device 600 and second electronic device 602, as represented by communication 606 and communication 608, respectively. At FIG. 6A, first electronic device 600 is in communication with audio device 604, but first electronic device 600 is not transmitting an audio signal to audio device 604, as illustrated by a dashed line representing communication 606. In contrast, second electronic device 602 is connected to audio device 604 and is transmitting an audio signal to audio device 604 to cause audio device 604 to output audio, as illustrated by a solid line representing communication 608. FIGS. 6A-6I illustrate that audio device 604 is connected to (e.g., actively in communication with a respective electronic device) and receiving audio data from a respective electronic device via a solid line representing communication 606 and/or communication 608. FIGS. 6A-6I illustrate that audio device 604 is in communication with a respective electronic device (e.g., passively in communication with a respective electronic device), but audio device 604 is not receiving audio data from the respective electronic device, via a dashed line representing communication 606 and/or communication 608.

At FIG. 6A, first electronic device 600 is displaying video 610, such as a television show, on display 612 (e.g., a television) and is outputting audio for video 610 at a speaker of display 612. In some embodiments, first electronic device 600 is in communication (e.g., wireless or wired) with display 612. In some embodiments, video 610 is being played back from local media stored at first electronic device 600. In some embodiments, video 610 is being played via a video stream (e.g., a live video stream) received over a network.

FIG. 6A also illustrates remote control 614, which is configured to transmit data (e.g., via RF communication, via Bluetooth, and/or via infrared) to first electronic device 600 based on user input that is detected at remote control 614. Remote control 614 includes selection region 614a, which includes a touch-sensitive surface for detecting tap, press, and swipe gestures, back button 614b, television button 614c, microphone button 614d, a play/pause button, volume control buttons, and a power button.

At FIG. 6A, second electronic device 602 is displaying, on display 616, audio application user interface 618 corresponding to an audio application of second electronic device 602. The audio application of second electronic device 602 is configured to cause second electronic device 602 to output audio (e.g., audio data corresponding to one or more audio tracks). At FIG. 6A, second electronic device 602 is connected to (e.g., via a wireless communication connection, such as Bluetooth, Wi-Fi, and/or Zigbee) audio device 604 so that second electronic device 602 causes audio device 604 to output the audio associated with audio application user interface 618, as illustrated by the solid line representing communication 608. In some embodiments, second electronic device 602 transmits audio data to audio device 604 via a wireless communication connection so that audio device 604 outputs the audio associated with audio application user interface 618 via speakers of audio device 604.

At FIG. 6A, audio application user interface 618 includes playback user interface object 618a, fast forward user interface object 618b, rewind user interface object 618c, and volume user interface object 618d. In some embodiments, while second electronic device 602 is causing playback of audio and in response to detecting user input selecting playback user interface object 618a, second electronic device 602 ceases (e.g., pauses) outputting audio and/or ceases (e.g., pauses) transmitting audio data to audio device 604. In some embodiments, while second electronic device 602 is not currently causing playback of audio and in response to detecting user input selecting playback user interface object 618a, second electronic device 602 initiates (e.g., resumes) output of audio and/or initiates (e.g., resumes) transmitting the audio data to audio device 604. In some embodiments, in response to detecting user input selecting volume user interface object 618d, second electronic device 602 causes audio device 604 to adjust a volume level of audio that is output via speakers of audio device 604.

At FIG. 6A, audio device 604 is in communication with first electronic device 600 (as represented by communication 606), but audio device 604 does not receive audio data from and/or does not output audio associated with first electronic device 600. In some embodiments, audio device 604 is configured to be in communication (e.g., passive communication) with multiple devices (e.g., first electronic device 600 and second electronic device 602) concurrently and/or simultaneously, but audio device 604 is configured to establish a connection (e.g., active communication and/or audio data communication) with and/or receive audio data from a single device (e.g., second electronic device 602 at FIG. 6A).

As set forth below, with reference to FIGS. 6D and 6E, in some embodiments, first electronic device 600 and second electronic device 602 are in communication with each other, such that first electronic device 600 and second electronic device 602 send and/or receive data indicative of whether first electronic device 600 and/or second electronic device 602 are currently causing playback of audio on audio device 604 (e.g., whether first electronic device 600 and/or second electronic device 602 are connected to and/or in active communication with audio device 604). In some embodiments, first electronic device 600 and/or second electronic device 602 initiate a connection with audio device 604 (e.g., send audio data to audio device 604 so that audio device 604 outputs audio associated with first electronic device 600 and/or second electronic device 602) based on communications between first electronic device 600, second electronic device 602, and audio device 604. In some such embodiments, even when first electronic device 600 is outputting audio corresponding to video 610, first electronic device 600 does not connect to audio device 604 when first electronic device 600 detects that audio device 604 is outputting audio corresponding to audio data received from second electronic device 602. Similarly, in some embodiments, even when second electronic device 602 is outputting audio corresponding to audio application user interface 618, second electronic device 602 does not connect to audio device 604 when second electronic device 602 detects that audio device 604 is outputting audio corresponding to audio data received from first electronic device 600.

In some embodiments, first electronic device 600 and/or second electronic device 602 are designated (e.g., programmatically designated with respect to one another) as having different levels of priority for connecting to audio device 604 and/or for otherwise transmitting audio data to audio device 604. For instance, in some embodiments, when first electronic device 600 is connected to audio device 604 and transmitting audio data to audio device 604, first electronic device 600 disconnects from audio device 604 in response to detecting a disconnect event. In some embodiments, second electronic device 602 connects to audio device 604 in response to detecting the disconnect event, such as when the disconnect event includes second electronic device 602 receiving and/or detecting user input accepting an incoming phone call and/or real-time communication (e.g., a video call). In some such embodiments, first electronic device 600 includes a lower priority designation than second electronic device 602, such that the disconnect event causes first electronic device 600 to disconnect from audio device 604 and cease transmitting an audio signal to audio device 604.

In some embodiments, first electronic device and/or second electronic device 602 are in communication with additional electronic devices that also have varying levels of priority designations for connecting to audio device 604. In some embodiments, the electronic devices that are in communication with one another are logged into and/or signed into the same account. In some embodiments, the electronic devices that are in communication with one another are in wireless communication with one another (e.g., direct wireless communication and/or indirect wireless communication via a server). In some embodiments, electronic devices that are most frequently used (and/or more likely to be used) by a user include higher priority level designations than electronic devices that are less frequently used (and/or less likely to be used) by the user. For example, a user that is signed into the same account on a mobile device (e.g., a smartphone), a tablet device, a laptop computer, and a television device may be likely to use the mobile device more frequently than the other devices because the user likely carries the mobile device around a home and when the user leaves the home. As such, the mobile device can include a higher priority designation than the tablet device, the laptop computer, and the television device. Similarly, the user may be likely to use the television device less frequently than the mobile device, the tablet device, and/or the laptop computer due to the television device having less mobility when compared to the other devices. Thus, in some embodiments, the television device includes a lower priority designation than the mobile device, the tablet device, and the laptop computer. As set forth below, in some embodiments, devices having lower priority designations than other devices disconnect from audio device 604 in response to a disconnect event associated with a device having a higher priority designation. Establishing such a hierarchy of devices with respect to audio device 604 enables a user of audio device 604 to receive audio data from an electronic device with which the user is most likely to interact.

At FIG. 6B, second electronic device 602 has ceased to display audio application user interface 618 and is not actively displaying a user interface on display 616 (e.g., second electronic device 602 is in an idle and/or locked mode). At FIG. 6B, second electronic device 602 has detected one or more user inputs to cease outputting audio associated with audio application user interface 618, such as a user input selecting playback user interface object 618a. Accordingly, second electronic device 602 remains in communication with audio device 604, but ceases to transmit audio data to audio device 604 so that audio device 604 does not output audio associated with audio application user interface 618, as illustrated by the dashed line representing communication 608.

At FIG. 6B, first electronic device 600 detects audio device 604 is in communication with audio device 604, as illustrated by the dashed line representing communication 606. However, at FIG. 6B, first electronic device 600 is not transmitting audio data to audio device 604. First electronic device 600 receives an indication that audio device 604 is not receiving audio data from second electronic device 602. In some embodiments, first electronic device 600 receives an indication from second electronic device 602 and/or from audio device 604 that audio device 604 is not outputting audio associated with audio data received from second electronic device 602. In some embodiments, first electronic device 600 receives an indication from second electronic device 602, audio device 604, and/or another electronic device that audio device 604 is not connected to and/or receiving audio data from any other electronic device that is different from first electronic device 600.

At FIG. 6B, in response to detecting audio device 604, first electronic device 600 determines whether or not a set of criteria for prompting a user to connect first electronic device 600 to audio device 604 is met. In some embodiments, the set of criteria includes a first criterion that is met when first electronic device 600 receives an indication that audio device 604 is not receiving audio data from an electronic device different from first electronic device 600. In some embodiments, the set of criteria includes a second criterion that is met when first electronic device 600 receives an indication that audio device 604 is powered on and/or in an active listening position. In some embodiments, the active listening position includes audio device 604 being positioned within ears of a user (e.g., for in-ear headphones) and/or being positioned over the cars of the user (e.g., for over-ear headphones). In some embodiments, the set of criteria includes a third criterion that is met when first electronic device 600 detects that audio device 604 is within the threshold distance of first electronic device 600 (e.g., within 50 feet, within 30 feet, within 25 feet, and/or within 10 feet of first electronic device 600). In some embodiments, the set of criteria includes a fourth criterion that is met when first electronic device 600 detects and/or receives an indication that audio device 604 is associated with first electronic device 600, such as audio device 604 being paired to and/or having been previously connected to first electronic device 600.

At FIG. 6B, first electronic device 600 determines that the set of criteria is met, and in accordance with the determination that the set of criteria is met, first electronic device 600 displays, on display 612, selectable option 620. At FIG. 6B, selectable option 620 is a pop-up and/or push notification that is overlaid on video 610. Selectable option 620 includes indicator 620a (e.g., an image and/or icon representing headphones and/or audio device 604) indicating that selectable option 620 corresponds to an audio device and/or audio device 604. Selectable option 620 also includes prompt 620b that prompts and/or instructs a user to provide a first user input, via remote control 614, to connect first electronic device 600 to audio device 604 and cause first electronic device 600 to transmit audio data to audio device 604.

At FIG. 6B, selectable option 620 is displayed in a top right portion of display 612. In some embodiments, selectable option 620 is displayed in a top left portion of display 612, a top center portion of display 612, a bottom right portion of display 612, a bottom left portion of display 612, and/or a bottom center portion of display 612. In some embodiments, while displaying selectable option 620, first electronic device 600 continues to cause playback of video 610 on display 612, such that displaying selectable option 620 does not interrupt playback of video 610. In some embodiments, prior to detecting user input that causes first electronic device 600 to connect to audio device 604, first electronic device 600 continues to cause audio output via speakers of display 612 while displaying selectable option 620. In some such embodiments, displaying selectable option 620 does not interrupt playback of video 610 on display 612 and/or playback of audio associated with video 610 via speakers of display 612.

At FIG. 6B, while video 610 continues playing and while selectable option 620 is displayed, remote control 614 detects activation of television button 614c via press gesture 650a, and transmits an indication of the input to first electronic device 600. While video 610 continues playing and while selectable option 620 is displayed, first electronic device 600 receives, from remote control 614, the indication corresponding to press gesture 650a of television button 614c and, in response, first electronic device 600 connects to audio device 604 and initiates a process for transmitting audio data to audio device 604, as shown in FIG. 6C.

In some embodiments, in response to detecting an absence of user input, such as press gesture 650a, for a predefined period of time after displaying selectable option 620 (e.g., within 45 seconds, within 30 seconds, and/or within 20 seconds of displaying selectable option 620), first electronic device 600 ceases to display selectable option 620 while continuing to display and/or cause playback of video 610.

In some embodiments, in response to detecting audio device 604 and when first electronic device 600 determines that a second set of criteria is met, first electronic device 600 connects to audio device 604 and transmits audio data to audio device 604 without displaying selectable option 620. In some such embodiments, first electronic device 600 connects to audio device 604 and transmits audio data to audio device 604 without receiving an indication of user input from remote control 614. In some embodiments, first electronic device 600 includes one or more sensors that provide data to first electronic device 600 indicative of an intent of a user to connect audio device 604 to first electronic device 600. In some embodiments, the second set of criteria includes a first criterion that is met when first electronic device 600 receives an indication from a camera sensor and/or a motion sensor that a user (e.g., a user in possession of audio device 604) is positioned in front of first electronic device 600 and/or within a threshold distance of first electronic device 600. The feedback received from the camera sensor and/or the motion sensor of first electronic device 600 confirms that a user is located in the same area and/or room as first electronic device 600. In contrast, detecting that audio device 604 is within a threshold distance of first electronic device 600 indicates that the user is close to first electronic device 600, but not necessarily located in an area where the user can view display 612 (e.g., when the user is in an adjacent room, but the user's view of display 612 is blocked via a wall and/or another obstruction). Therefore, the feedback received from the camera sensor and/or the motion sensor of first electronic device 600 indicates that the user is more likely to intend to connect audio device 604 to first electronic device 600 and, in some embodiments, first electronic device 600 forgoes displaying selectable option 620 based on feedback from the camera sensor and/or the motion sensor.

In some embodiments, the second set of criteria includes a second criterion that is met when first electronic device 600 determines that a strength of a signal between first electronic device 600 and audio device 604 is at and/or exceeds a threshold strength indicating that audio device 604 is within a threshold distance of first electronic device 600. In some embodiments, the second set of criteria includes a third criterion that is met when first electronic device 600 receives an indication from audio device 604 that audio device is not receiving audio data from an electronic device different from first electronic device 600. In some embodiments, the second set of criteria includes a fourth criterion that is met when first electronic device 600 detects that audio device 604 is associated with first electronic device 600, such as audio device 604 being paired to and/or having been previously connected to first electronic device 600. In some embodiments, the second set of criteria includes a fifth criterion that is met when first electronic device 600 receives an indication from audio device 604 that audio device 604 is powered on and/or in the active listening position.

At FIG. 6C, in response to receiving the indication of press gesture 650a, first electronic device 600 connects to audio device 604 and transmits audio data corresponding to video 610 to audio device 604, as illustrated by the solid line representing communication 606. At FIG. 6C, second electronic device 602 is in communication with audio device 604, but second electronic device 602 is not transmitting audio data to audio device 604, as illustrated by the dashed line representing communication 608. Therefore, in response to receiving an indication of user input corresponding selectable option 620, first electronic device 600 transmits audio data to audio device 604. Displaying selectable option 620 prompting a user to provide press gesture 650a enables a user of first electronic device 600 to quickly cause first electronic device 600 to connect to audio device 604 without requiring the user to navigate to a settings user interface and/or otherwise interrupt playback of video 610.

As set forth above, in some embodiments, first electronic device 600 initiates a process to disconnect audio device 604 in response to detecting and/or receiving an indication of a disconnect event. At FIG. 6D, first electronic device 600 is connected to audio device 604 and is transmitting audio data corresponding to video 610 to audio device 604, as illustrated by the solid line representing communication 606. At FIG. 6D, second electronic device 602 is in communication with audio device 604, but second electronic device 602 is not transmitting audio data to audio device 604, as illustrated by the dashed line representing communication 608.

At FIG. 6D, second electronic device 602 receives an incoming phone call and displays incoming call user interface 622. Incoming call user interface 622 includes accept user interface object 622a, decline user interface object 622b, reminder user interface object 622c, message user interface object 622d, and participant indicator 622e. Participant indicator 622c includes an identifier and/or name of a user that initiated the call to second electronic device 602 (e.g., ‘Jane Appleseed’). In some embodiments, in response to detecting user input corresponding to decline user interface object 622b, second electronic device 602 declines and/or ignores the incoming phone call and, optionally, provides an indication to first electronic device 600 that the incoming phone call was declined (e.g., so that first electronic device 600 maintains the connection with audio device 604 and continues to provide audio data to audio device 604). In some embodiments, in response to detecting user input corresponding to reminder user interface object 622c, second electronic device 602 declines and/or ignores the incoming phone call and displays a reminder user interface for scheduling a reminder to call the user associated with participant indicator 622e at a time after the current time (and, optionally, provides the indication to first electronic device 600 that the incoming phone call was declined). In some embodiments, in response to detecting user input corresponding to message user interface object 622d, second electronic device 602 declines and/or ignores the incoming phone call and displays a messaging user interface for sending a message to a device of the user associated with participant indicator 622e (and, optionally, provides the indication to first electronic device 600 that the incoming call was declined).

At FIG. 6D, second electronic device 602 detects user input 650b (e.g., a tap gesture) corresponding to selection of accept user interface object 622a. In response to detecting user input 650b, second electronic device 602 accepts the incoming phone call, initiates a phone call between second electronic device 602 and a device of the user associated with participant indicator 622e, and provides an indication to first electronic device 600 that the incoming phone call was accepted. In response to receiving the indication that the incoming phone call was accepted via second electronic device 602, first electronic device 600 initiates a process for disconnecting audio device 604 and ceasing to transmit audio data corresponding to video 610 to audio device 604. Second electronic device 602 also initiates a process for connecting to audio device 604, such that second electronic device 602 transmits audio data corresponding to the phone call to audio device 604, as shown at FIG. 6E.

At FIG. 6E, second electronic device 602 is connected to audio device 604 and is transmitting audio data corresponding to the phone call to audio device 604, as illustrated by the solid line representing communication 608. In contrast, at FIG. 6E, first electronic device 600 is in communication with audio device 604, but first electronic device 600 is not transmitting audio data to audio device 604, as illustrated by the dashed line representing communication 606. Second electronic device 602 also displays active call user interface 624 indicating that a phone call between second electronic device 602 and a device of a user associated with participant indicator 622e is ongoing. In some embodiments, in response to detecting end call user interface object 624a of active call user interface 624, second electronic device 602 initiates a process for disconnecting from audio device 604 and ceasing transmitting audio data to audio device 604. In some such embodiments, first electronic device 600 receives an indication (e.g., from second electronic device 602 and/or audio device 624) that second electronic device 602 is disconnected from audio device 604. In some embodiments, in response to receiving the indication, first electronic device 600 displays selectable option 620 and/or connects to audio device 604 to initiate transmitting audio data corresponding to video 610 to audio device 604.

Acceptance of the incoming phone call via second electronic device 602 is a disconnect event that causes first electronic device 600 to disconnect from audio device 604 and cease transmitting audio data corresponding to video 610 to audio device 604. Enabling first electronic device 600 to disconnect from audio device 604 and second electronic device 602 to connect to audio device 604 in response to user input 650b, allows a user to quickly and easily transition audio output of audio device 604 between devices. In some embodiments, acceptance of the incoming audio phone call received via second electronic device 602 is a disconnect event for first electronic device 600 because first electronic device 600 includes a lower priority designation than second electronic device 602. In some embodiments, acceptance of the incoming audio phone call received via second electronic device 602 is not a disconnect event for first electronic device 600 when first electronic device 600 includes a higher priority designation than second electronic device 602.

At FIGS. 6D and 6E, the disconnect event that causes first electronic device 600 to disconnect from audio device 604 (and cause second electronic device 602 to connect to audio device 604) is acceptance of an incoming audio phone call received via second electronic device 602. In some embodiments, the disconnect event includes receiving the incoming audio phone call (e.g., regardless of whether the user accepts the incoming audio phone call via user input 650b) via second electronic device 602, acceptance of and/or receiving an incoming real-time communication (e.g., a video call) via second electronic device 602, initiation of an outgoing audio phone call and/or real-time communication via second electronic device 602, and/or playback of a media file via second electronic device 602.

As set forth above, first electronic device 600 forgoes displaying selectable option 620 when the set of criteria is not met. In some embodiments, the set of criteria includes a first criterion that is met when first electronic device 600 detects that audio device 604 is within a threshold distance of first electronic device 600. At FIG. 6F, first electronic device 600 is in communication with audio device 604, but first electronic device 600 is not transmitting audio data to audio device 604, as illustrated by the dashed line representing communication 606. Similarly, at FIG. 6F, second electronic device 602 is in communication with audio device 604, but second electronic device 602 is not transmitting audio data to audio device 604, as illustrated by the dashed line representing communication 608. Therefore, at FIG. 6F, audio device 604 is not outputting audio received from either first electronic device 600 or second electronic device 602.

At FIGS. 6F and 6G, arrangement 626 illustrates the positioning of first electronic device 600, second electronic device 602, and audio device 604 with respect to one another. Arrangement 626 is provided for a more complete understanding, but is not part of the user interfaces displayed via first electronic device 600 and/or second electronic device 602. Arrangement 626 includes distance indicator 626a indicating a distance threshold (e.g., distances extending from first electronic device 600) between first electronic device 600 and audio device 604 (and, optionally, between first electronic device 600 and second electronic device 602). While audio device 604 is positioned within the distance threshold of first electronic device 600, first electronic device 600 detects that the first criterion of the set of criteria is met, e.g., that audio device 604 is within the distance threshold of first electronic device 600. In some embodiments, distance indicator 626a is indicative of maximum distances at which a short-range communication connection between first electronic device 600 and audio device 604 can be established (e.g., a maximum distance at which communication 606 between first electronic device 600 and audio device 604 can be reliably established). The distance threshold can be non-uniform, can be affected by numerous variables (e.g., wireless interference, air humidity, or the like), and can include points in space in three dimensions, all of which are intended to be within the scope of this disclosure. Thus, the graphical representation of distance indicator 626a is merely exemplary. Furthermore, the figures are not necessarily to scale and are included merely as a visual aid. Thus, the size and scale of features depicted in the figures are not intended as a limitation on a distance required to establish a connection.

At FIG. 6F, arrangement 626 indicates that audio device 604 is positioned outside of (e.g., at a distance further than) the distance threshold represented by distance indicator 626a from first electronic device 600. At FIG. 6F, first electronic device 600 detects audio device 604 and determines that audio device 604 is positioned further than the threshold distance from first electronic device 600. In some embodiments, first electronic device 600 determines that audio device 604 is positioned further than the threshold distance from first electronic device 600 based on a strength of a signal between first electronic device 600 and audio device 604 (e.g., a strength of the signal between first electronic device 600 and audio device 604 is below a threshold signal strength indicative of the threshold distance). At FIG. 6F, in response to determining that audio device 604 is positioned outside of (e.g., further away than) the threshold distance from first electronic device 600, first electronic device 600 forgoes displaying selectable option 620 and continues displaying and/or playing video 610. Even though second electronic device 602 is not connected to audio device 604 and/or transmitting audio data to audio device 604, first electronic device 600 still forgoes displaying selectable option 620 when audio device 604 is positioned outside of the threshold distance from first electronic device 600.

In some embodiments, first electronic device 600 forgoes displaying selectable option 620 in accordance with a determination that audio device 604 is positioned outside of the threshold distance of first electronic device 600 because a user of audio device 604 is unlikely to intend to connect audio device 604 to first electronic device 600 (e.g., the user is not within a suitable distance for viewing display 612).

In some embodiments, first electronic device 600 forgoes displaying selectable option 620 when first electronic device 600 is displaying a particular type of content. In some embodiments, the set of criteria includes a second criterion that is met when first electronic device 600 is displaying a first type of content. In some embodiments, first electronic device 600 forgoes displaying selectable option 620 when first electronic device 600 is not displaying the first type of content regardless of whether or not the set of criteria is met. In some such embodiments, first electronic device 600 displaying the first type of content is not a criterion of the set of criteria, such that when first electronic device 600 display a second type of content, different from the first type of content, first electronic device 600 to forgoes making a determination as to whether or not the set of criteria is met.

At FIG. 6G, first electronic device 600 is in communication with audio device 604, but first electronic device 600 is not transmitting audio data to audio device 604, as illustrated by the dashed line representing communication 606. Similarly, at FIG. 6G, second electronic device 602 is in communication with audio device 604, but second electronic device 602 is not transmitting audio data to audio device 604, as illustrated by the dashed line representing communication 608. Therefore, at FIG. 6G, audio device 604 is not outputting audio received from either first electronic device 600 or second electronic device 602.

At FIG. 6G, first electronic device 600 is displaying screen saver 628. In some embodiments, first electronic device 600 determines whether the first type of content is being displayed prior to determining whether the set of criteria for displaying selectable option 620 is met. In some embodiments, the first type of content includes playback of a media file and/or a content library for selecting a media file. In some embodiments, the media file includes video 610 and/or another video, a video game, a music track, and/or other multimedia that is currently playing, streaming, paused, and/or being output via first electronic device 600. In some embodiments, the content library for selecting a media file includes a user interface having one or more user interface objects corresponding to applications and/or media files that, when selected via user input, cause first electronic device 600 to playback and/or otherwise display a media file. In some embodiments, the first type of content does not include a screen saver and/or a user interface associated with inactivity of first electronic device 600.

At FIG. 6G, first electronic device 600 determines that screen saver 628 is not the first type of content. In some embodiments, in accordance with the determination that screen saver 628 is not the first type of content, first electronic device 600 forgoes determining whether the set of criteria for displaying selectable option 620 is met. In some embodiments, first electronic device 600 determines that the set of criteria for displaying selectable option 620 is not met based on the determination that screen saver 628 is not the first type of content. At FIG. 6G, in accordance with the determination that screen saver 628 is not the first type of content, first electronic device 600 forgoes displaying selectable option 620 even though audio device 604 is within the threshold distance of first electronic device 600 (e.g., as illustrated by arrangement 626 and distance indicator 626a) and even though audio device 604 is not outputting audio associated with audio data received from second electronic device 602.

In some embodiments, first electronic device 600 forgoes displaying selectable option 620 in accordance with a determination that an audio routing setting of first electronic device 600 is disabled. For example, at FIG. 6H, first electronic device 600 displays settings user interface 630. Settings user interface 630 is associated with audio settings for content that is output by first electronic device 600. At FIG. 6H, settings user interface 630 includes audio routing user interface object 630a that is currently in an enabled and/or on position. When audio routing user interface object 630a is in the enabled and/or on position, first electronic device 600 displays selectable option 620 when displaying the first type of content and in accordance with a determination that the set of criteria is met. When audio routing user interface object 630a is in a disabled and/or off position, first electronic device 600 forgoes displaying selectable option 620 when displaying the first type of content regardless of whether or not the set of criteria is met. In some embodiments, when audio routing user interface object 630a is in the disabled and/or off position, first electronic device 600 forgoes determining whether the set of criteria is met. In some embodiments, when audio routing user interface object 630a is in the disabled and/or off position, first electronic device 600 forgoes detecting audio device 604 and/or communicating with audio device 604 via communication 606.

At FIG. 6H, while first electronic device 600 displays settings user interface 630 with a focus on audio routing user interface object 630a, remote control 614 detects activation of selection region 614a via press gesture 650c, and transmits an indication of the input to first electronic device 600. While first electronic device 600 displays settings user interface 630 with the focus on audio routing user interface object 630a, first electronic device 600 receives, from remote control 614, the indication corresponding to press gesture 650c of activation region 614a and, in response, first electronic device 600 disables the audio routing setting and displays audio routing user interface object 630a in the disabled and/or off position.

In some embodiments, first electronic device 600 is configured to concurrently and/or simultaneously transmit audio data to multiple audio devices (e.g., when the set of criteria is met for each audio device). At FIG. 6I, first electronic device 600 is connected to audio device 604 and is transmitting audio data corresponding to video 610 to audio device 604, as illustrated by the solid line representing communication 606. At FIG. 6I, first electronic device 600 detects second audio device 632 via communication 634 with second audio device 632. However, first electronic device is not connected to second audio device 632 and is not transmitting audio data corresponding to video 610 to second audio device 632.

At FIG. 6I, first electronic device 600 determines that a third set of criteria associated with second audio device 632 is met. In some embodiments, the third set of criteria includes a first criterion that is met when first electronic device 600 receives an indication that second audio device 632 is not connected to an electronic device different from first electronic device 600. In some embodiments, the third set of criteria includes a second criterion that is met when first electronic device 600 receives an indication that second audio device 632 is powered on and/or in the active listening position. In some embodiments, the third set of criteria includes a third criterion that is met when first electronic device 600 detects that second audio device 632 is within the threshold distance of first electronic device 600. In some embodiments, the third set of criteria includes a fourth criterion that is met when first electronic device 600 detects and/or receives an indication that second audio device 632 is associated with first electronic device 600, such as second audio device 632 being paired to and/or having been previously connected to first electronic device 600.

At FIG. 6I, in response to detecting second audio device 632 and in accordance with a determination that the third set of criteria is met, first electronic device 600 displays, on display 612, selectable option 636 corresponding to second audio device 632. At FIG. 6I, in response to receiving an indication corresponding to press gesture 650d on television button 614c from remote control 614, first electronic device 600 connects to second audio device 632 and transmits audio data concurrently to second audio device 632 and audio device 604.

FIGS. 7A-7C are a flow diagram illustrating a method for managing audio output using a computer system in accordance with some embodiments. Method 700 is performed at a computer system (e.g., 100, 300, 500, or 600) (e.g., an electronic device; a set top device, a smart audio speaker, and/or a digital media player) that is in communication with (e.g., wired communication and/or wireless communication) a display generation component (e.g., 612). Some operations in method 700 are, optionally, combined, the orders of some operations are, optionally, changed, and some operations are, optionally, omitted.

As described below, method 700 provides an intuitive way for managing audio output. The method reduces the cognitive burden on a user for transitioning audio output between devices, thereby creating a more efficient human-machine interface. For battery-operated computing devices, enabling a user to transition audio output between devices faster and more efficiently conserves power and increases the time between battery charges.

The computer system (e.g., 600), while displaying (e.g., causing the display generation component to display by transmitting data (e.g., image data and/or video data) to the display generation component), via the display generation component (e.g., 612), content of a first type (e.g., 610) (e.g., actively displaying content, such as playing, streaming, and/or otherwise displaying a multimedia file and/or causing playback of audio, displaying a content library for selecting content to actively display, and/or not displaying content of a second type, such as a screen saver and/or an inactive display screen), detects (702) an audio device (e.g., 604) (e.g., an external audio device configured to output audio generated and/or received from the computer system, such as wireless headphones).

In response to detecting the audio device (704) and in accordance with a determination that a set of criteria is met (e.g., the set of criteria is met when the audio device is not currently outputting audio received from a device different from the computer system, when the audio device is powered on and/or in a listening position (e.g., within cars of a user and/or over the cars of the user), when the audio device is associated with the computer system (e.g., the audio device has been paired to and/or otherwise is and/or has been in communication with the computer system), and/or when the audio device is within a threshold distance of the computer system (e.g., within 50 feet, within 25 feet, and/or within 10 feet of the computer system)), the computer system (e.g., 600) displays (706) (e.g., causing the display generation component to display by transmitting data (e.g., image data and/or video data) to the display generation component) a selectable option (e.g., 620) (e.g., a pop-up and/or push notification prompting a user to provide a user input) that, when selected via user input (e.g., 650a) (e.g., selected via user input from a remote control while a focus is displayed on the selectable option, and/or selected via the user providing the user input prompted by the selectable option), causes the computer system (e.g., 600) to provide output content audio to the audio device (e.g., 604) (e.g., the computer system transmits audio data to the audio device so that the audio device outputs content audio corresponding to the content of the first type displayed via the display generation component of the computer system). In some embodiments, the computer system transmits audio data corresponding to the content audio to speakers of the computer system prior to detecting user input selecting the selectable option and the computer system subsequently forgoes transmitting the audio data corresponding to the content audio to the speakers so that the speakers do not output the content audio in response to detecting user input selecting the selectable option. In some embodiments, the computer system transmits audio data to both the speakers of the computer system and the audio device in response to detecting user input selecting the selectable option.

In response to detecting the audio device (704) and in accordance with a determination that the set of criteria is not met (e.g., the set of criteria is not met when the audio device is currently outputting audio received from a device different from the computer system (e.g., an electronic device, such as a smartphone, a tablet, and/or a laptop and/or desktop computer), when the audio device is not powered on and/or in the listening position, when the audio device is not associated with the computer system, and/or when the audio device is outside of the threshold distance of the computer system), the computer system (e.g., 600) forgoes (708) displaying the selectable option (e.g., 620) (e.g., the computer system forgoes transmitting audio data corresponding to the content audio to the audio device and, optionally, continues transmitting audio data corresponding to the content audio to the speakers so that the speakers continue outputting the content audio).

Displaying the selectable option in accordance with the determination that the set of criteria is met enables a user to connect the audio device to the computer system without navigating to a settings user interface and/or another user interface that would interrupt the content of the first type, which reduces the number of inputs needed to perform an operation and/or provides the user with an improved experience for viewing and/or listening to the content.

In some embodiments, the computer system (e.g., 600), while displaying (e.g., causing the display generation component to display by transmitting data (e.g., image data and/or video data) to the display generation component), via the display generation component (e.g., 612), the selectable option (e.g., 620), detects (710) a first user input (e.g., 650a) (e.g., a first user input corresponding to a remote control device in communication with the computer system) corresponding to the selectable option (e.g., 620) (e.g., the first user input is a user input prompted by the selectable option and/or a user input selecting the selectable option (e.g., when a focus is on the selectable option)). In response to detecting the first user input (e.g., 650a) (e.g., receiving an indication of the first user input via a remote control device in communication with the computer system), the computer system (e.g., 600) provides (712) output content audio to the audio device (e.g., 604) (e.g., causing the audio device to output the output content audio via speakers of the audio device).

Providing the output content audio to the audio device in response to detecting the first user input enables a user to listen to the output content audio corresponding to the content of the first type without having to navigate to another user interface and/or interrupt the content of the first type, which reduces the number of inputs needed to perform an operation and/or provides the user with an improved experience for viewing and/or listening to the content.

In some embodiments, the computer system (e.g., 600), while providing output content audio to the audio device (e.g., 604) (e.g., causing the audio device to output the output content audio via speakers of the audio device), detects (714) a disconnect condition (e.g., incoming phone call received via second electronic device 602) (e.g., receiving an indication of a disconnect event from an external device that is in communication with the audio device (e.g., the external device is paired to the audio device and/or the external device is within a predefine distance of the audio device), where the disconnect event includes an incoming phone call received via the external device, an incoming real-time communication received via the external device, initiating playback of content via the external device, initiating a connection between the audio device and the external device, and/or initiating disconnecting the audio device from the computer system). In response to detecting the disconnect condition, the computer system (e.g., 600) initiates (716) a process to cease providing output content audio to the audio device (e.g., 604) (e.g., ceasing causing the audio device to output the output content audio via speakers of the audio device, ceasing transmitting audio data associated with the output content audio to the audio device, and/or ceasing a connection between the computer system and the audio device).

Initiating the process to cease providing output content audio to the audio device in response to detecting the disconnect condition enables a user to quickly switch a connection between the audio device and the computer system to a connection between the audio device and an external device without having to provide additional user inputs, which reduces the number of inputs needed to perform an operation and/or performs an operation when a set of conditions has been met without requiring further user input.

In some embodiments, the computer system (e.g., 600), while displaying (e.g., causing the display generation component to display by transmitting data (e.g., image data and/or video data) to the display generation component), via the display generation component (e.g., 612), the selectable option (e.g., 620), detects (718) that a predefined amount of time (e.g., five seconds, ten seconds, twenty seconds, and/or thirty seconds) has passed since first displaying the selectable option (e.g., 620) (e.g., a predefined amount of time starting from when the computer system causes the selectable option to be displayed via the display generation component and without detecting user input corresponding to the selectable option (e.g., user input selecting the selectable option (e.g., when a focus is on the selectable option) and/or user input prompted by the selectable option)). In response to detecting that the predefined amount of time has passed since first displaying the selectable option (e.g., 620), the computer system (e.g., 600) ceases (720) displaying the selectable option (e.g., 620) (e.g., causing the display generation component to cease displaying by transmitting data to the display generation component).

Ceasing displaying the selectable option in response to detecting that the predefined amount of time has passed since first displaying the selectable option reduces an amount of interruption of the content of the first type caused by the selectable option, which performs an operation when a set of conditions is met without requiring further user input and/or provides the user with an improved experience for viewing and/or listening to the content.

In some embodiments, the computer system (e.g., 600) displays the selectable option (e.g., 620) concurrently with the content of the first type (e.g., 610) (e.g., the selectable option is overlaid on a portion of the content of the first type, but does not otherwise interrupt playback of the content of the first type). In some embodiments, the content of the first type is a video that is currently playing on the display generation component and the video does not pause and/or otherwise stop being played and/or displayed (e.g., except for a portion covered and/or blocked via the selectable option) when the selectable option is displayed. Displaying the selectable option concurrently with the content of the first type enables a user to connect the audio device to the computer system without having to navigate to another user interface and interrupt the content of the first type, which reduces the number of inputs needed to perform an operation and/or provides the user with an improved experience for viewing and/or listening to the content.

In some embodiments, the set of criteria includes a first criterion that is met when (e.g., in accordance with a determination that) the computer system (e.g., 600) detects that the audio device (e.g., 604) is not outputting audio associated with an external device (e.g., 602) (e.g., the audio device is not being caused, via a data transmission from an external device, to output audio via speakers of the audio device). In some embodiments, the first criterion is a sufficient condition for meeting the set of criteria. In some embodiments, the first criterion is a necessary, but not sufficient, condition for meeting the set of criteria. Displaying the selectable option when the audio device is not outputting audio associated with an external device reduces the likelihood of inadvertently switching audio output of the audio device to the content output audio, which provides the user with an improved experience for viewing and/or listening to content.

In some embodiments, the set of criteria includes a second criterion that is met when (e.g., in accordance with a determination that or the computer system detects and/or receives an indication that) the audio device (e.g., 604) is in an active listening position (e.g., the audio device includes one or more sensors that indicate whether the audio device is positioned within the ears of a user (e.g., a person) (e.g., when the audio device includes in-ear headphones) and/or positioned over the ears of a user (e.g., a person) (e.g., when the audio device includes over-the-ear headphones) and the computer system receives an indication from the audio device that the audio device is positioned within the ears of the user and/or over the ears of the user). In some embodiments, the second criterion is a sufficient condition for meeting the set of criteria. In some embodiments, the second criterion is a necessary, but not sufficient, condition for meeting the set of criteria.

Displaying the selectable option when the audio device is in an active listening position increases the likelihood that a user associated with the audio device intends to listen to the output content audio corresponding to the content of the first type and reduces an amount of interruption to the content of the first type, which reduces the number of inputs needed to perform an operation and/or provides the user with an improved experience for viewing and/or listening to content.

In some embodiments, the set of criteria includes a third criterion that is met when (e.g., in accordance with a determination that) the computer system (e.g., 600) detects that the audio device (e.g., 604) has been previously associated with the computer system (e.g., 600) (e.g., the computer system is paired to the audio device and/or has otherwise been connected to the audio device and caused the audio device to output audio associated with audio data of the computer system). In some embodiments, the third criterion is a sufficient condition for meeting the set of criteria. In some embodiments, the third criterion is a necessary, but not sufficient, condition for meeting the set of criteria. Displaying the selectable option when the audio device has been previously associated with the computer system reduces interruptions to the content of the first type for audio devices that are unlikely to be connected to the computer system, which reduces a processing power of the computer system.

In some embodiments, the set of criteria includes a fourth criterion that is met when (e.g., in accordance with a determination that) the computer system (e.g., 600) detects that the audio device (e.g., 604) is within a threshold distance (e.g., a distance indicated by distance indicator 626a) (e.g., within 50 feet, within 30 feet, within 20 feet, and/or within 10 feet) of the computer system (e.g., 600) (e.g., the computer system detects a strength of a connection signal between the computer system and the audio device exceeds a threshold amount indicating that the audio device is within the threshold distance of the computer system). In some embodiments, the fourth criterion is a sufficient condition for meeting the set of criteria. In some embodiments, the fourth criterion is a necessary, but not sufficient, condition for meeting the set of criteria. Displaying the selectable option when the audio device is within the threshold distance of the computer system reduces interruptions to the content of the first type for audio devices that are unlikely to be connected to the computer system, which reduces a processing power of the computer system.

In some embodiments, the content of the first type (e.g., 610) includes playback of a media file (e.g., a video, a video game, a music track, and/or other multimedia that is currently playing, streaming, paused, and/or being output) and/or a content library for selecting a media file (e.g., a content library that includes one or more applications and/or one or more media files that the computer system can cause to playback and displayed on the display generation component). Displaying the selectable option when the content of the first type includes the media file and/or the content library for selecting a media file increases the likelihood that a user associated with the audio device intends to connect the audio device to the computer system, which reduces a processing power of the computer system.

In some embodiments, the content of the first type (e.g., 610) does not include a screen saver (e.g., 628) (e.g., an image, a set of images, and/or a video that is displayed, via the display generation component, in response to the computer system detecting an absence of user input and/or an absence of active playback of media). In some embodiments, the set of criteria is not met in accordance with a determination that the content is a screen saver. Forgoing detecting the audio device when the computer system displays, via the display generation component, a screen saver reduces an amount of power consumption and/or processing power of the computer system when the audio device is unlikely to be connected to the computer system, which improves a battery life of the computer system and/or reduces an amount of power consumed by the computer system.

In some embodiments, in accordance with a determination that an audio output setting is disabled (e.g., via audio routing user interface object 630a) (e.g., an audio output setting that, when enabled, causes the computer system to detect the audio device and/or other audio devices), the computer system (e.g., 600) forgoes (722) displaying the selectable option (e.g., 620) (e.g., the computer system forgoes transmitting data to the display generation component that would cause the display generation component to display the selectable option regardless of whether the set of criteria is met or not met). Forgoing displaying the selectable option when an audio output setting is disabled enables the computer system to conserve power when the user does not intend to connect the audio device to the computer system, which improves a battery life of the computer system and/or reduces an amount of power consumed by the computer system.

In some embodiments, in response to detecting the audio device (724) (e.g., 604) and in accordance with a determination that a second set of criteria is met (726) (e.g., the second set of criteria is met when the computer system includes one or more sensors that provide an indication that a user intends to connect the audio device the computer system, where the indication includes a camera sensor and/or motion sensor detecting a user positioned in front of the computer system and/or within a threshold distance of the computer system, the computer system detecting that a strength of a connection signal between the computer system and the audio device is at and/or exceeds a threshold indicating that the audio device is within the threshold distance of the computer system, the computer system receives an indication from the audio device that the audio device is not outputting audio associated with audio data from an external device, different from the computer system, the computer system detects that the audio device has been previously paired to and/or otherwise previously connected to the computer system, and/or the computer system receives an indication from the audio device that the audio device is in the active listening position), the computer system (e.g., 600) forgoes (728) displaying the selectable option (e.g., 620) (e.g., the computer system forgoes transmitting data to the display generation component that would cause the display generation component to display the selectable option) and provides (730) output content audio to the audio device (e.g., 604) (e.g., causing the audio device to output the output content audio via speakers of the audio device without detecting user input).

Forgoing displaying the selectable option and providing the output content audio to the audio device in accordance with a determination that the second set of criteria is met enables the computer system to connect to the audio device without user input, which performs an operation when a set of conditions has been met without requiring further user input.

In some embodiments, the computer system (e.g., 600), while displaying (e.g., causing the display generation component to display by transmitting data (e.g., image data and/or video data) to the display generation component), via the display generation component (e.g., 612), the content of the first type (e.g., 610) (e.g., actively displaying content, such as playing, streaming, and/or otherwise displaying a multimedia file and/or causing playback of audio, displaying a content library for selecting content to actively display, and/or not displaying content of a second type, such as a screen saver and/or an inactive display screen), the computer system (e.g., 600) detects (732) a second audio device (632) (e.g., an external audio device configured to output audio generated and/or received from the computer system, such as wireless headphones), different from the audio device (604). In response to detecting the second audio device (734) (e.g., 632), different from the audio device (e.g., 604), and in accordance with a determination that a third set of criteria is met (e.g., the third set of criteria is met when the second audio device is not currently outputting audio received from a device different from the computer system, when the second audio device is powered on and/or in a listening position (e.g., within cars of a user and/or over the cars of the user), when the second audio device is associated with the computer system (e.g., the second audio device has been paired to and/or otherwise is and/or has been in communication with the computer system), and/or when the second audio device is within a threshold distance of the computer system (e.g., within 50 feet, within 25 feet, and/or within 10 feet of the computer system)), the computer system (e.g., 600) displays (736) (e.g., causing the display generation component to display by transmitting data (e.g., image data and/or video data) to the display generation component) a second selectable option (e.g., 636) (e.g., a pop-up and/or push notification prompting a user to provide a user input), that when selected via user input (e.g., 650d) (e.g., selected via user input from a remote control while a focus is displayed on the second selectable option, and/or selected via the user providing the user input prompted by the second selectable option), causes the computer system (e.g., 600) to provide output content audio to the second audio device (e.g., 632) (e.g., the computer system transmits audio data to the second audio device so that the second audio device outputs content audio (e.g., the same content audio as the audio device) corresponding to the content of the first type displayed via the display generation component of the computer system). In response to detecting the second audio device (734) (e.g., 632), different from the audio device (e.g., 604), and in accordance with a determination that the third set of criteria is not met (e.g., the third set of criteria is not met when the second audio device is currently outputting audio received from a device different from the computer system (e.g., an electronic device, such as a smartphone, a tablet, and/or a laptop and/or desktop computer), when the second audio device is not powered on and/or in the listening position, when the second audio device is not associated with the computer system, and/or when the second audio device is outside of the threshold distance of the computer system), the computer system (e.g., 600) forgoes (738) displaying the second selectable option (e.g., 636) (e.g., the computer system forgoes transmitting audio data corresponding to the content audio to the second audio device and, optionally, continues transmitting audio data corresponding to the content audio to the speakers so that the speakers continue outputting the content audio).

Displaying the second selectable option in accordance with the determination that the third set of criteria is met enables a user to connect the second audio device to the computer system without navigating to a settings user interface and/or another user interface that would interrupt the content of the first type, which reduces the number of inputs needed to perform an operation and/or provides the user with an improved experience for viewing and/or listening to the content.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the delivery of audio to users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to cause an audio device to output audio from a device that is likely to be interacted with by the user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of routing audio output, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, a determination as to whether to transition audio output between devices can be based on non-personal information data or a bare minimum amount of personal information, such as the content being requested by the device associated with a user or publicly available information.

What is claimed is:

1. A computer system configured to communicate with a display generation component and one or more input devices, comprising:
one or more processors; and
memory storing one or more programs configured to be executed by the one or more processors, the one or more programs including instructions for:
while displaying, via the display generation component, content of a first type, detecting that a proximity between an external device and the computer system is less than a threshold distance; and
in response to detecting that the proximity between the external device and the computer system is less than the threshold distance:
in accordance with a determination that a set of criteria is met, wherein the set of criteria includes a first criterion that is met when the computer system receives information, via the one or more input devices, indicating that a user is located at a predefined position relative to the computer system, displaying, via the display generation component, a selectable option that, when selected via user input, causes the computer system to provide output content audio to the external device; and
in accordance with a determination that the set of criteria is not met, forgoing displaying the selectable option.

2. The computer system of claim 1, wherein the one or more programs further include instructions for:
while displaying, via the display generation component, the selectable option, detecting a first user input corresponding to the selectable option; and
in response to detecting the first user input, providing output content audio to the external device.

3. The computer system of claim 2, wherein the one or more programs further include instructions for:
while providing output content audio to the external device, detecting a disconnect condition; and
in response to detecting the disconnect condition, initiating a process to cease providing output content audio to the external device.

4. The computer system of claim 1, wherein the one or more programs further include instructions for:
while displaying, via the display generation component, the selectable option, detecting that a predefined amount of time has passed since first displaying the selectable option; and
in response to detecting that the predefined amount of time has passed since first displaying the selectable option, ceasing displaying the selectable option.

5. The computer system of claim 1, wherein displaying the selectable option includes concurrently displaying the selectable option and the content of the first type.

6. The computer system of claim 1, wherein detecting that the proximity between the external device and the computer system is less than the threshold distance includes detecting that a strength of a signal between the computer system and the external device exceeds a threshold signal strength.

7. The computer system of claim 1, wherein the set of criteria includes a second criterion that is met when the computer system detects that the external device is not outputting audio associated with a second external device.

8. The computer system of claim 1, wherein the set of criteria includes a third criterion that is met when the computer system detects that the external device is associated with the computer system.

9. The computer system of claim 1, wherein the set of criteria includes a fourth criterion that is met when the computer system receives an indication that the external device is in an active listening position.

10. The computer system of claim 1, wherein the one or more input devices includes a motion sensor and/or a camera sensor.

11. The computer system of claim 1, wherein the content of the first type includes playback of a media file and/or a content library for selecting a media file.

12. The computer system of claim 1, wherein the information received via the one or more input devices indicating that the user is located at the predefined position relative to the computer system includes information indicating that the user is located within a threshold distance of the computer system.

13. The computer system of claim 1, wherein the information received via the one or more input devices indicating that the user is located at the predefined position relative to the computer system includes information indicating that the user is located in front of the computer system.

14. A non-transitory computer-readable storage medium storing one or more programs configured to be executed by one or more processors of a computer system that is in communication with a display generation component and one or more input devices, the one or more programs including instructions for:
while displaying, via the display generation component, content of a first type, detecting that a proximity between an external device and the computer system is less than a threshold distance; and
in response to detecting that the proximity between the external device and the computer system is less than the threshold distance:
in accordance with a determination that a set of criteria is met, wherein the set of criteria includes a first criterion that is met when the computer system receives information, via the one or more input devices, indicating that a user is located at a predefined position relative to the computer system, displaying, via the display generation component, a selectable option that, when selected via user input, causes the computer system to provide output content audio to the external device; and
in accordance with a determination that the set of criteria is not met, forgoing displaying the selectable option.

15. A method, comprising
at a computer system that is in communication with a display generation component and one or more input devices:
while displaying, via the display generation component, content of a first type, detecting that a proximity between an external device and the computer system is less than a threshold distance; and
in response to detecting that the proximity between the external device and the computer system is less than the threshold distance:
in accordance with a determination that a set of criteria is met, wherein the set of criteria includes a first criterion that is met when the computer system receives information, via the one or more input devices, indicating that a user is located at a predefined position relative to the computer system, displaying, via the display generation component, a selectable option that, when selected via user input, causes the computer system to provide output content audio to the external device; and
in accordance with a determination that the set of criteria is not met, forgoing displaying the selectable option.
